(19) United States
(12) Patent Application Publication
(10) Pub. No.: US 2025/0111538 A1
(43) Pub. Date: Apr. 3, 2025

(54) SYSTEM AND METHOD FOR PART PROFILE IDENTIFICATION

(71) Applicant: Spirit AeroSystems, Inc., Wichita, KS (US)

(72) Inventor: Andrew Roberts, Wichita, KS (US)

(21) Appl. No.: 18/477,132

(22) Filed: Sep. 28, 2023

(51) Int. Cl. G06T 7/90; G06T 7/194; G06T 7/50

(52) U.S. Cl. CPC G06T 7/90; G06T 7/194; G06T 7/50

(57) ABSTRACT

A part is positioned between a display and an image capturing device pointed toward the display. A visual feedback loop is conducted using the display and the image capturing device to refine a part profile picture on the display corresponding to a profile of the part in an image captured by the image capturing device. The visual feedback loop recursively projects on a display screen an input picture containing a pattern region; captures images of the part while the display is displaying the input picture; based on the captured image, refines a picture that more closely corresponds to the profile of the part; and sets the refined image to be a next input image. The feedback loop iteratively refines the picture projected on the display screen until it becomes the part profile picture.

### FIELD

The present disclosure generally relates to a method and system for part profile identification.

### BACKGROUND

When a part is manufactured and chemically processed, identification tags on the part may get stripped. The part once stripped of its identification tag needs to be re-identified to ensure the part is being correctly stored for future use. To re-identify the part after stripping, conventional tools are used to measure the extent of surfaces or features of physical parts. However, it can be difficult to measure the surface and features accurately, particularly for parts with complex surface geometries. There is still a need for expedient, highly accurate technologies for identifying unmarked parts.

It has been proposed to use computer vision methods for this purpose, but the inventor believes that existing computer vision methods are often inaccurate, typically from blurred boundaries caused by poor lighting or incompatible background coloring. Further, the inherent limitations of an optical sensing setup hinder precise measurements. Higher precision methods utilizing laser scanners have also been tried but have their own limitations, including cost, safety, and scalability.

### SUMMARY

In one aspect, a method of identifying a part comprises positioning the part between a display and an image capturing device pointed toward the display. A visual feedback loop is conducted using the display and the image capturing device to refine a part profile picture on the display corresponding to a profile of the part in an image captured by the image capturing device.

In another aspect, a system for identifying a profile of a part comprises a display comprising a display screen. The display is configured to project pictures on the display screen. An image capturing device is pointed toward the display. The system is configured to hold the part between the display and the image capturing device. The image capturing device is oriented to capture images of the part with the display screen in background behind the part. A profile identification module controls the display and the image capturing device for conducting a visual feedback loop to refine a part profile picture on the display screen corresponding to the profile of the part.

In one aspect, a method of measuring one or more dimensions of a part comprises positioning the part between a display and an image capturing device spaced apart along a z-axis. The z-axis position of the part is determined. A part profile picture on the display is refined to correspond to a profile of the part in an image captured by the image capturing device. The one or more dimensions of the part are determined based on the z-axis position and the part profile picture.

Other aspects will be in part apparent and in part pointed out hereinafter.

### BRIEF DESCRIPTION OF THE DRAWINGS

FIG. 1 is a schematic illustration of a system for part profile identification according to the present disclosure;

FIG. 2 is a flow chart illustrating the steps and decision points of a visual feedback loop conducted by the system of FIG. 1;

FIG. 3 is a flow chart illustrating the steps and decision points of a color setting routine conducted by the system of FIG. 1;

FIG. 4A is an illustration of a display of the system of FIG. 1 from the vantage of an image capturing device of the system of FIG. 1 when a part is positioned between the display and the image capturing device and the display is inactive.

FIG. 4B is an illustration similar to FIG. 4B but showing the display projecting an initial input picture including a pattern of alternating color sections on the display screen;

FIG. 4C is an illustration similar to FIG. 4B but showing the display projecting a refined input picture on the display screen;

FIG. 4D is an illustration similar to FIG. 4C but showing the display projecting a further refined input picture on the display screen;

FIG. 4E is an illustration similar to FIG. 4C but showing the display projecting a still further refined input picture on the display screen;

FIG. 4F is an illustration similar to FIGS. 4A-4E but showing the display when the part is removed from the system and the display is displaying a final part profile picture corresponding to the profile of the part;

FIG. 5 is an illustration of a portion of an airplane with a cockpit section in front of a large display of a system for part profile identification in accordance with the present disclosure while the display is displaying an input picture including a pattern of alternating color sections;

FIG. 5A is an illustration of the display of FIG. 5 displaying a part profile picture corresponding to the profile of the cockpit of the airplane;

FIG. 6A is a top plan view illustration of the system for part profile identification supporting a part so that the surface of the part is orthogonal to the z-axis;

FIG. 6B is an illustration similar to FIGS. 4A-4E but showing the system as illustrated in FIG. 6A;

FIG. 7A is a top plan view illustration of the system for part profile identification supporting a part so that the surface of the part is skewed from the z-axis;

FIG. 7B is an illustration similar to FIGS. 4A-4E but showing the system as illustrated in FIG. 7A;

FIG. 7C is an illustration of a grayscale z-axis depth map of the scene in FIG. 7B taken by the depth camera;

FIG. 8 is a flow chart illustrating the steps of a method for determining part dimensions using the system of FIGS. 6A and 7A;

FIG. 9A is an illustration of the display from the vantage point of the image capturing device immediately prior to a calibration process, while the display is inactive and no part is in front of the display;

FIG. 9B is an illustration similar to FIG. 9A during a first stage of the calibration process;

FIG. 9C is an illustration similar to FIG. 9A during a later stage of the calibration process; and

FIG. 9D is an illustration similar to FIG. 9A during a final stage of the calibration process.

Corresponding parts are given corresponding reference numbers throughout the drawings.

### DETAILED DESCRIPTION

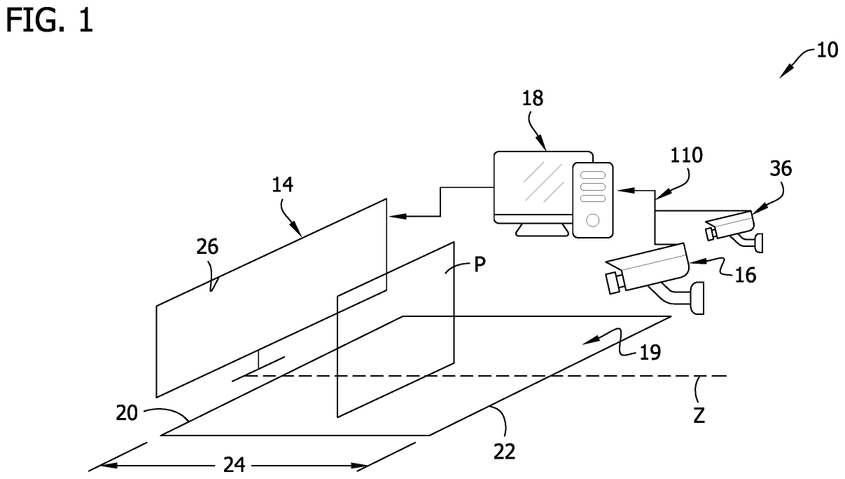

Referring to FIG. 1, an exemplary embodiment of a system for part profile identification is generally indicated at reference number 10. The system 10 broadly comprises a display 14, at least one image capturing device 16, and a part stage 19 between the display and the image capturing device. The part stage 19 holds a part P in front of the image capturing device 16 so that the imaging capturing device captures images of the part P with the display 14 in background behind the part. As explained more fully below, the system 10 comprises a profile identification module 18 that controls the image capturing device 16 and the display 14 to conduct a visual feedback loop that generates a part profile picture on the display 14. The part profile picture includes image content (e.g., a part silhouette or a part profile outline set against a contrasting background color) that corresponds to the profile of the part P. The part profile picture can reflect the profile of outer perimeter features of the part and/or inner perimeter features of the part P (e.g., holes or other apertures of any shape formed through the part P thickness), from the vantage point of the image capturing device 16. In an embodiment, the system 10 uses the part profile picture to determine a part type of the part P, e.g., by comparing the part profile picture to a database storing information about the profile shapes of various part types. Hence, the system 10 can be used to determine a part number of a part P after the painted-on part number has been stripped during processing. Additionally, the part profile picture may be used to determine part dimensions, as will be explained in further detail below.

As shown in FIG. 1, the part stage 19 has a first side 20, an opposing second side 22, and a length 24 extending along a z-axis from the first side 20 to the second side 22. The display 14 is positioned adjacent to the first side 20 of the part stage 19, and the image capturing device 16 is positioned adjacent to the second side 22 of the part stage 19. The image capturing device 16 is directed toward the display 14 so that images captured by the image capturing device include at least a portion of the display, preferably, the entire display. The part P is positionable on the part stage 19 between the first side 20 and the second side 22, such that the part is positioned between the display 14 and the image capturing device 16. The part P may be positioned at any suitable location along the part stage length 24 so that portions of the part profile of interest are visible in the images captured by the image capturing device 16 with the display 14 in background.

The display 14 includes a display screen 26 and is configured for projecting pictures on the display screen. In an exemplary embodiment, the display 14 is a flat screen display, such as an LED or LCD-type flat screen display. Other types of display devices such as digital pattern projectors may also be used without departing from the scope of the disclosure. In an embodiment, pictures projected from the display screen 26 are pixel-based images. Throughout this disclosure, “pixel-based” is used broadly to describe a display that uses pixels to define pictures projected on a display screen 26. The term is not used as a synonym for “pixelated.” At least some of the pixel-based pictures projected on the display screen 26 can contain one or more pattern regions, e.g., patterns of geometric sections (e.g., squares or rectangles, circles, triangles) in alternating, contrasting colors. The geometric sections in a given pattern have a “section size” measured in pixels. For example, a square section may have a section size of 100×100 pixels, 10×10 pixels, etc. Each pixel projected onto the display has the same “pixel size” measured in a standard unit of dimensional measurement. For example, a Dell P2210 LCD display has a 22″ nominal screen size and 1680×1050-pixel resolution, for a pixel size of about 0.282 mm×0.282 mm. It will be understood that the pixel sizes of displays will vary.

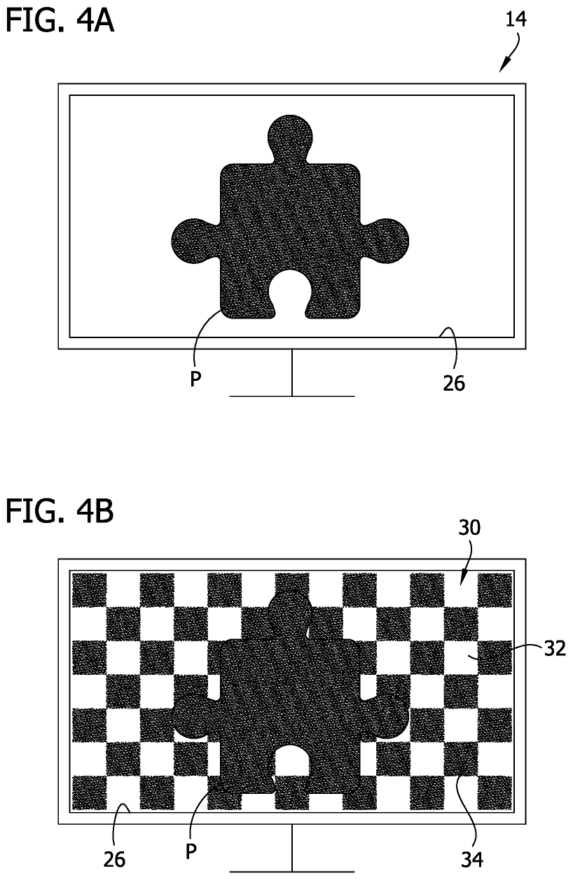

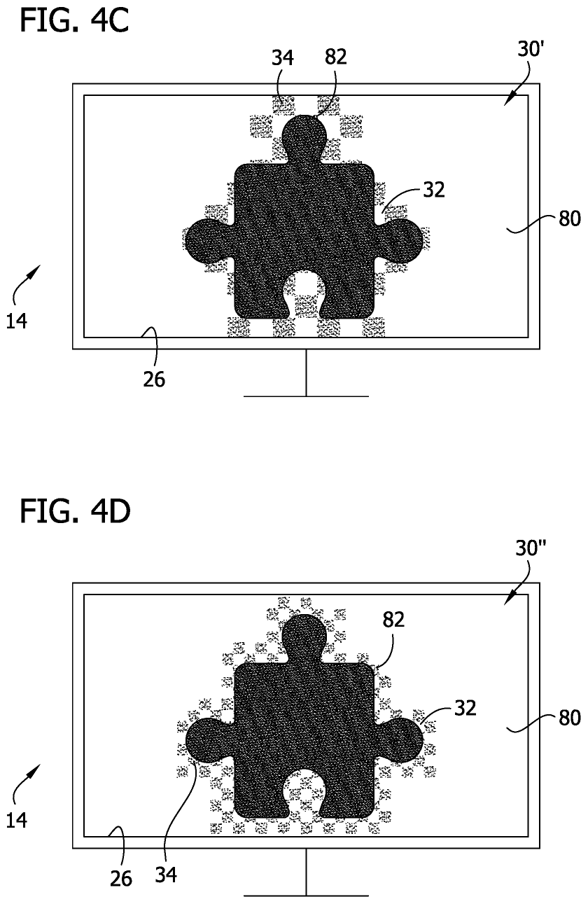

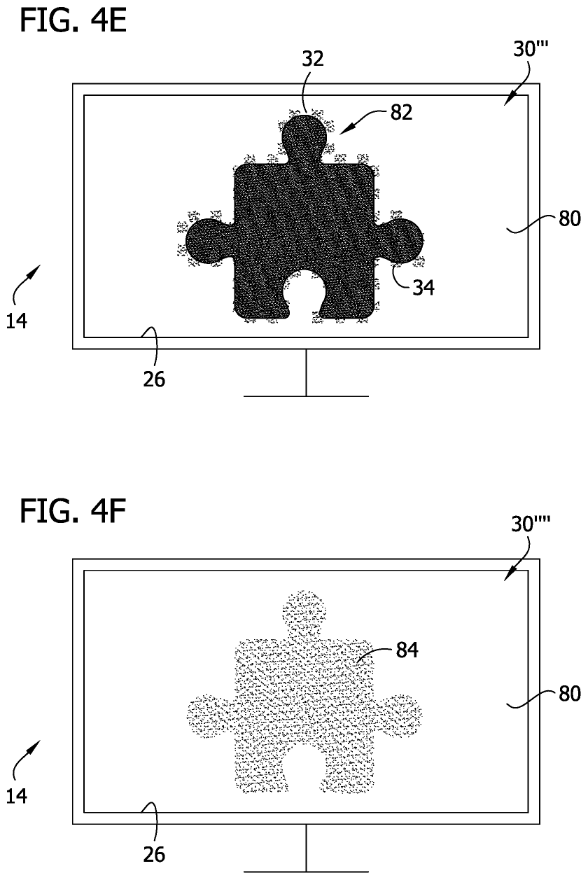

FIG. 4B provides an exemplary illustration of the display 14 projecting a picture 30 consisting of pattern of alternating color sections 32, 34. FIG. 4B shows the display 14 from the vantage point of the image capturing device 16 while a part P is positioned between the image capturing device and the display screen 26. As shown, the picture 30 comprises a pattern of contrasting color sections 32, 34. More particularly, the picture 30 includes alternating rectangular color sections 32, 34 in contrasting colors. Each color section 32 is a background color section rendered in a background color (e.g., white or any other suitable background color). Each color section 34 is a contrast color section rendered in a contrast color with sufficient contrast from the background color so that the profile identification module 18 can discern in a captured image of the display screen 26 where the edges between background and contrast colors are located. In an embodiment, the background and contrast colors do not need to be uniformly utilized, as one with ordinary skill in the art would understand, the system 10 may allow for localized contrast with the part P, such as, “quadrant-by-quadrant” as dictated by each subsection of a profile edge. In an exemplary embodiment, the system 10 uses a default contrast color of green. Green may be advantageous because conventional digital cameras have more sensors for green detection than other colors. However, other colors can be selected for the contrast color without departing from the scope of the disclosure. And as will be explained in further detail below, in certain embodiments, the profile image module is configured to conduct a contrast color selection routine that sometimes results in the contrast color being changed from the default green color.

The image capturing device 16 captures images of the part P positioned on the part stage 19 and at least a portion of the display 14 in background behind the part stage 19. FIG. 1 illustrates a single image capturing device 16, but it should be understood by one having ordinary skill in the art that the system 10 can include any number of image capturing devices 16. It should also be understood by one having ordinary skill in the art that in systems 10 having multiple image capturing devices 16, the image capturing devices 16 can be of the same type or of different types. The image capturing device 16 shown in FIG. 1 is a still-image digital camera, but other image capturing devices 16 such as video cameras can also be used with the system 10. Although multiple image capturing devices 16 increase the cost of the system 10, systems 10 having multiple image capturing devices 16 may increase the accuracy and/or speed of identification of the part P, particularly if each image capturing device 16 is directed at the part P at a different angle. When the part P is placed on the part stage 19 between the image capturing device 16 and the display 14, the part P obstructs a portion of the view of the display screen 26 from the perspective of the image capturing device 16. In the illustrated embodiment, the system 10 is oriented horizontally such that the display 14, part P, and image capturing device 16 are oriented in a generally horizontal alignment. It is also contemplated that embodiments of the system could be oriented vertically with the display 14 supporting the part P and the image capturing device 16 positioned vertically above the display 14.

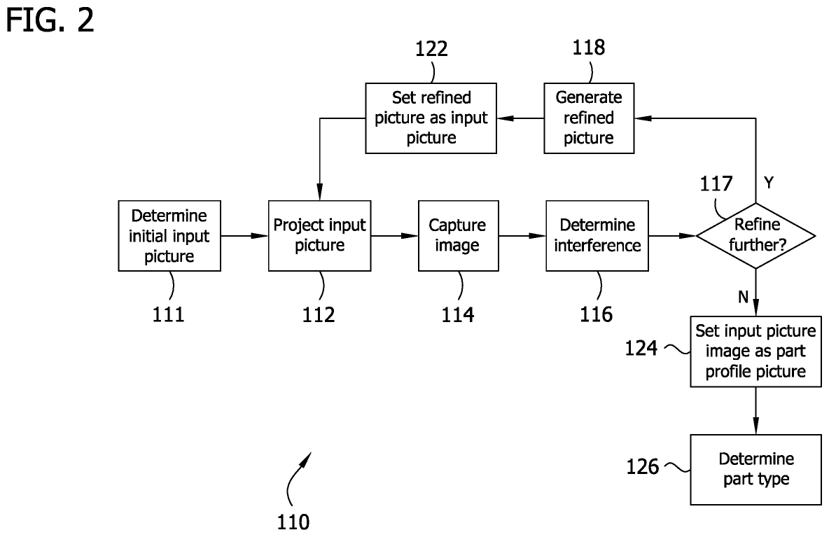

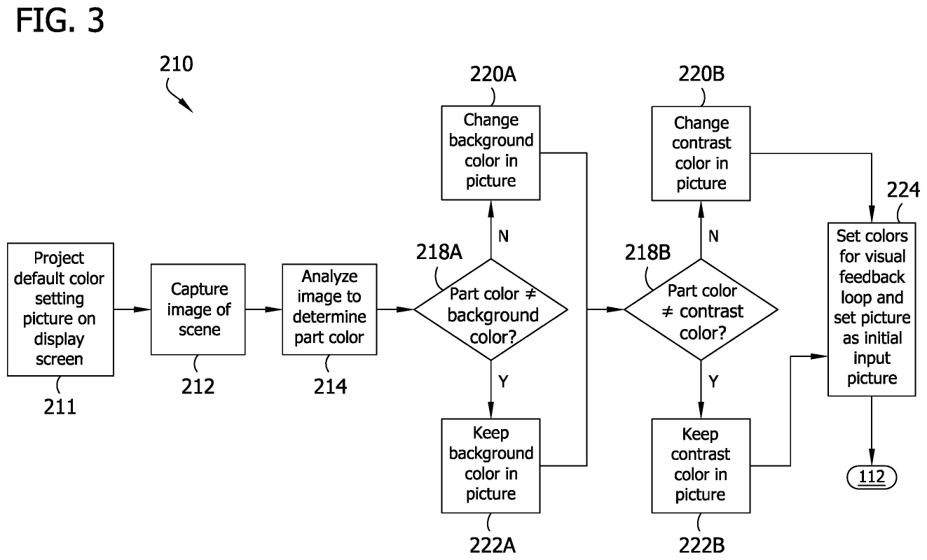

The profile identification module 18 is operatively connected (e.g., wireless or wired connection) to the display 14 and the image capturing device 16. Referring to FIG. 2, the profile identification module 18 controls the display 14 and the image capturing device 16 for conducting a visual feedback loop 110 to iteratively refine the pictures projected on the display screen 26 until a refined picture is determined to be the final part profile picture that corresponds to the profile of the part. Before conducting the visual feedback loop 110, the part P is placed at the desired location on the part stage 19. FIG. 4A shows the perspective of the image capturing device 16 when the part P is properly placed on the part stage while the display 14 is inactive. The visual feedback loop begins at step 111 when the profile identification module 18 determines an initial input picture for the visual feedback loop 110. In some embodiments, step 111 only involves loading a default initial input picture from memory. But in an exemplary embodiment, step 111 comprises a color-setting sub-process 210 for determining the background and contrast colors, as shown in FIG. 3. Suitably, the initial input picture comprises a repeating pattern of contrasting color sections 32, 34 (e.g., a checkerboard pattern of rectangular color sections) that covers and extends contiguously across the entire display screen 26. In other words, the pattern region of the initial input picture can fill the entire display screen 26.

Referring to FIG. 3, the color determination sub-process 210 begins with a first step 211 of projecting a default color setting pattern picture onto the display screen 26. The default color setting pattern picture includes background color sections 32 rendered in a default background color (e.g., white) and contrast color sections 34 rendered in a default contrast color (e.g., green). In step 212, the profile identification module 18 directs the image capturing device 16 to capture an image of the scene. FIG. 4B provides an example of an image captured by an image capturing device at step 212. At step 214, the profile identification module 18 analyzes the captured image to determine whether the part has sufficient contrast with both default colors (decision points 218A, 218B). If the part lacks sufficient contrast from either the default background color of the default contrast color (e.g., in FIG. 4B, the part lacks sufficient color contrast with the contrast color 34), the profile identification module 18 changes the default color in the picture to another color with appropriate contrast (steps 220A, 220B). If both default colors have sufficient contrast, the profile identification module 18 keeps the default colors (steps 222A, 222B). After any required changes to the pattern colors have been made, at step 224, the profile identification module 18 sets the picture as the initial input picture for step 111 of the visual feedback loop 110. In addition, the profile identification module 18 sets the background and contrast colors in the picture as the background and contrast colors for the remainder of the visual feedback loop 110. The visual feedback loop 110 of FIG. 2 then proceeds from step 112.

At step 112, the profile identification module 18 directs the display 14 to project the initial input picture on the display screen 26. In the initial input picture, the pattern can fill the entire display screen 26 and each background color section 32 and contrast color section 34 has a relatively large section size. At step 114, the profile identification module 18 directs the image capturing device 16 to capture an image of the scene. The image captured in step 114 includes the part P and the initial input picture projected on the display screen 26 in background behind the part P. At step 116, the profile identification module 18 analyzes the image captured in step 114 to determine interference of the part P with the input picture. And at decision point 117, the profile identification module 18 assesses whether the input picture should be further refined to better correspond to the profile of the part P. If the profile identification module 18 determines that the input picture should be further refined, in step 118 the profile identification module generates a refined picture, as will be explained in further detail below. Then in step 122, the profile identification module 18 sets the refined picture as the input picture and repeats steps 112, 114, 116 and decision point 117 based on the new input picture. The loop of steps 112, 114, 116, 118, and 122 is repeated recursively until the input picture projected on the display screen 26 is determined to correspond with the profile of the part P and is set to be the part profile picture (step 124).

An exemplary process by which the visual feedback loop 110 can refine the pictures projected onto the display screen 26 will now be described in detail. In step 116 where part interference is determined, the profile identification module 18 analyzes the image to determine, for each color section 32, 34, whether the part P interferes with (e.g., occludes) (i) an entirety of the color section, (ii) none of the color section, or (iii) a portion of the color section less than the entirety. At step 118, the profile identification module 18 uses the information about part interference to generate the refined picture by adjusting the color of the pixels of at least some of the color sections 32, 34 in the input picture. More particularly, for each color section 32, 34 (i) that is entirely occluded by the part P, the profile identification module 18 renders the pixels for that color section in the contrast color in the refined picture. For each color section 32, 34 (ii) that has no part interference, the profile identification module 18 renders the pixels for that color section in the background color in the refined picture. And for each color section 32, 34 (iii) that is partially occluded by the part P, the profile identification module 18 renders the pixels in a refined pattern of smaller contrasting color sections. So for example, if an input picture included an alternating pattern of contrasting color sections 32, 34 having a section size of 100×100 pixels, the profile identification module could subdivide each color section (iii) that is partially occluded by the part P into quadrants, such that each color section in the next refined picture has a section size of 50×50 pixels.

Accordingly, as can be understood by reference to FIGS. 4C-4F, after the initial input picture, each successive refined input picture comprises a contrast color region 84 that is totally occluded by the part P (see FIG. 4F where the part has been removed), a background color region 80 wherein there is no part interference, and at least one pattern region 82 between the background color region and the contrast color region. Moreover, with each successive refined picture, the region size of the pattern region 82 becomes progressively smaller, and the section size the color sections 32, 34 in becomes progressively smaller. An example of this progression can be seen in FIGS. 4C-4E, which depict three successive input pictures 30′, 30″, 30″′. As can be seen, in the first picture 30′, the pattern region 82 is made up of relatively large contrasting color sections 32, 34 and has a relatively large region size. In the second picture 30″, which is more refined, the pattern region 82 is made up of smaller color sections 32, 34 and has a smaller region size. In the third picture 30″′, the pattern region 82 is made up of still smaller color sections 32, 34 and has a yet smaller region size.

Referring to FIG. 4F, eventually the visual feedback loop 110 refines a part profile picture 30″″ in which the background region 80 defines a silhouette of the part P, at which point the profile identification module 18 determines that no further refinement of the picture is required. In some embodiments, the profile identification module 18 repeats the visual feedback loop 110 until the contrasting color sections 32, 34 in the pattern region 82 of a picture cannot be subdivided and/or until no partially occluded color sections in a pattern region of a picture can be identified in an image captured by the image capturing device 16. In an embodiment, the visual feedback loop 110 continues until the color sections 32, 34 in the pattern region 82 of the picture reach a predefined minimum section size (e.g., a section size in an inclusive range of from 1×1 pixel to 10×10 pixels).

Accordingly, as shown in FIG. 2, the profile identification module 18 iteratively repeats the recursive steps of the visual feedback loop 110 until the profile identification module 18 determines, at decision point 117, that no further refinement of the pattern region 82 is needed. The profile identification module 18 then sets the current input picture as the part profile picture (step 124). Once the part profile picture has been determined, the profile identification module 18 can optionally conduct step 126 to determine the part type for the part P based on the part profile picture. In an embodiment, step 126 comprises comparing the part profile P with part type shapes (e.g., pictures of parts organized by part type) stored in a part type database (not shown). The profile identification module 18 identifies the part type shape stored in the database that is the closest match for the part profile picture and determines that the part P has the same part type.

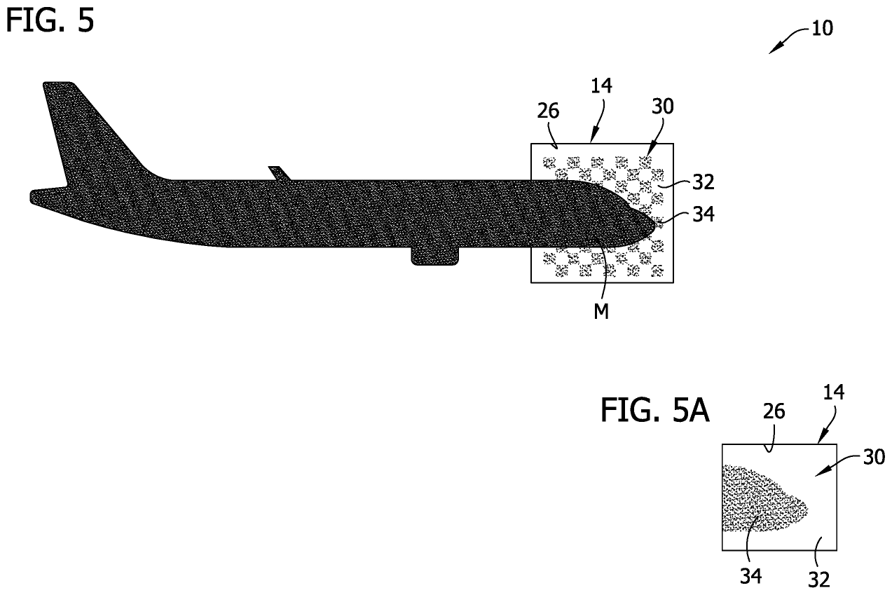

Referring to FIGS. 5 and 5A, the inventor contemplates that the system 10 can be used for identifying the profile of very large articles of manufacture M, including as aerostructures such as cockpit sections, wing sections, fuselage sections, tail sections, or entire airframes.

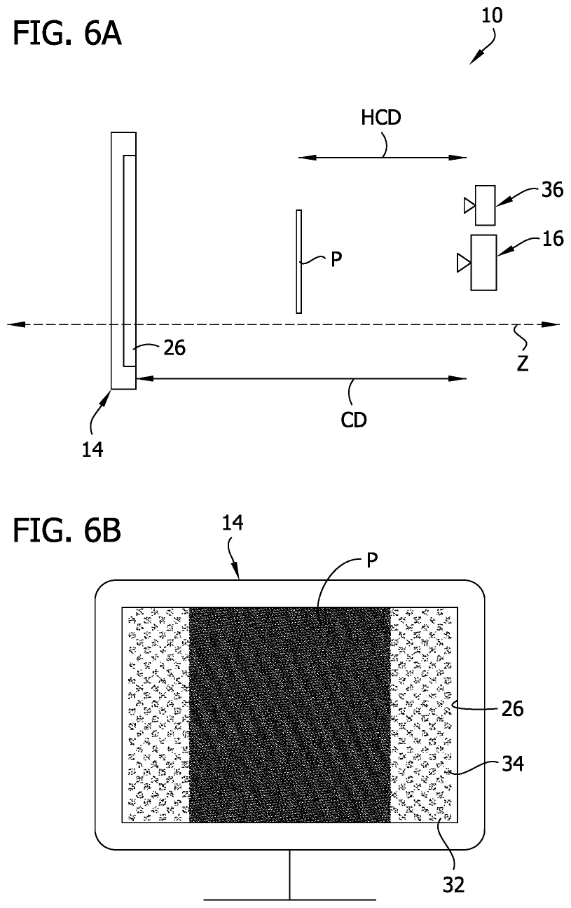

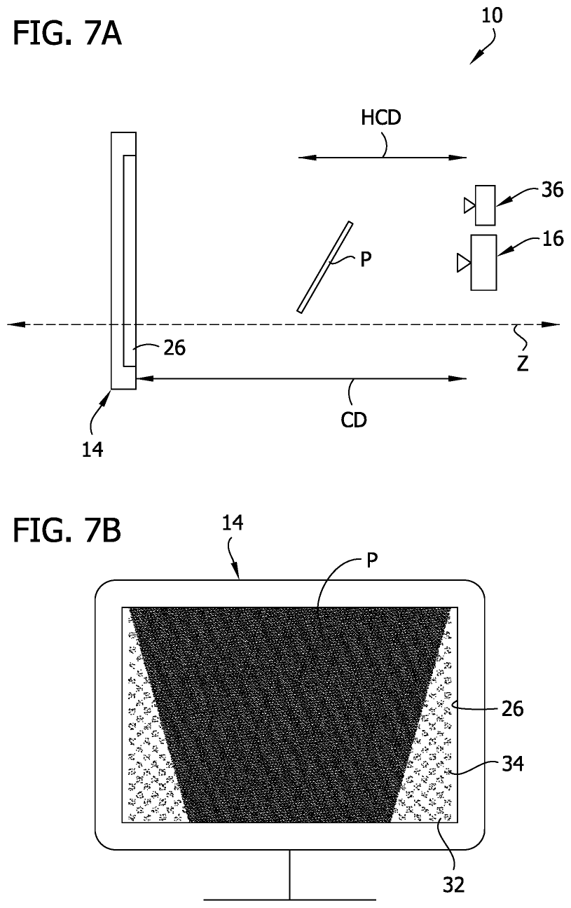

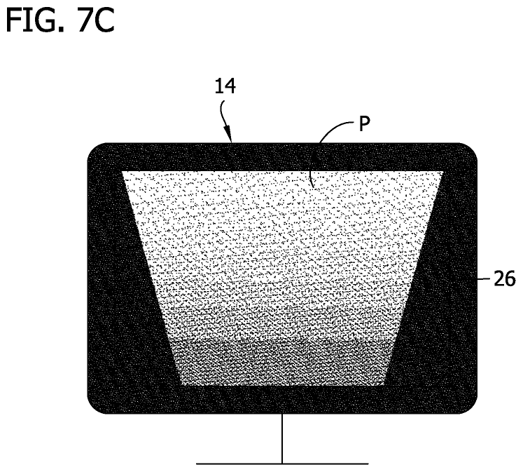

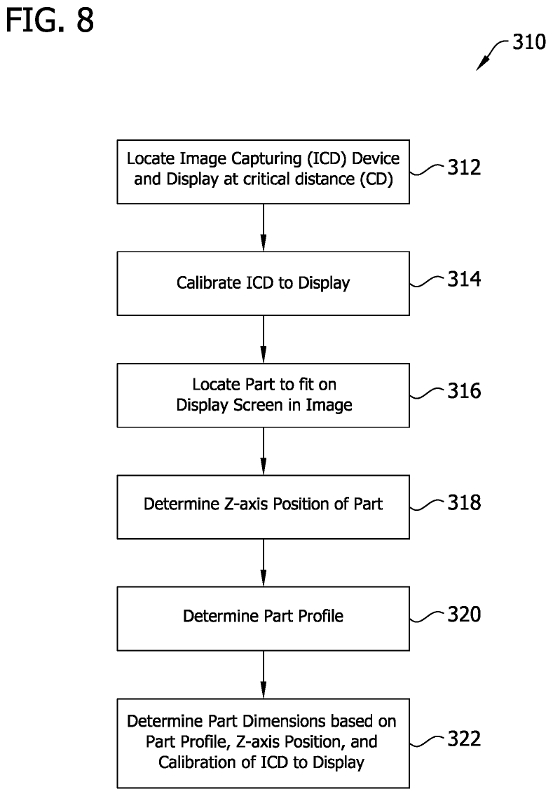

Referring to FIGS. 6A-6B, 7A-7C, and 8, with additional information, the system 10 can be used to make dimensional measurements of the part P based on the part profile picture created using the visual feedback loop 110 described above. In order to use the system 10 for measuring the dimensions of a part P, locations of the display 14, the part P, and the image capturing device along the z-axis must be established. Initially, it is helpful to place the image capturing device 16 at a critical distance CD from the display 14 along the z-axis (step 312 of FIG. 8). Referring to FIGS. 6A and 7A, in one embodiment, the critical distance CD is set so that the image capturing device 16 can sense the contrasting color sections 32, 34 of the smallest possible section size for the display 14. Those skilled in the art will appreciate that, when the image capturing device 16 is located further from the display 14 than the critical distance CD, the image capturing device is not able to detect the smallest possible contrasting color sections 32, 34; and when the image capturing device 16 is located closer to the display 14 than the critical distance CD, the image capturing device is unable to fully subdivide the display screen resolution to saturate the image sensor of the image capturing device.

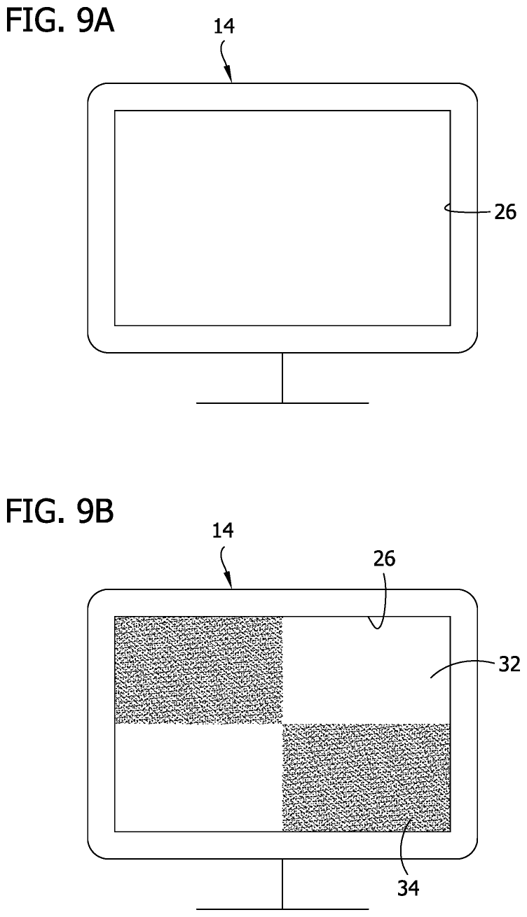

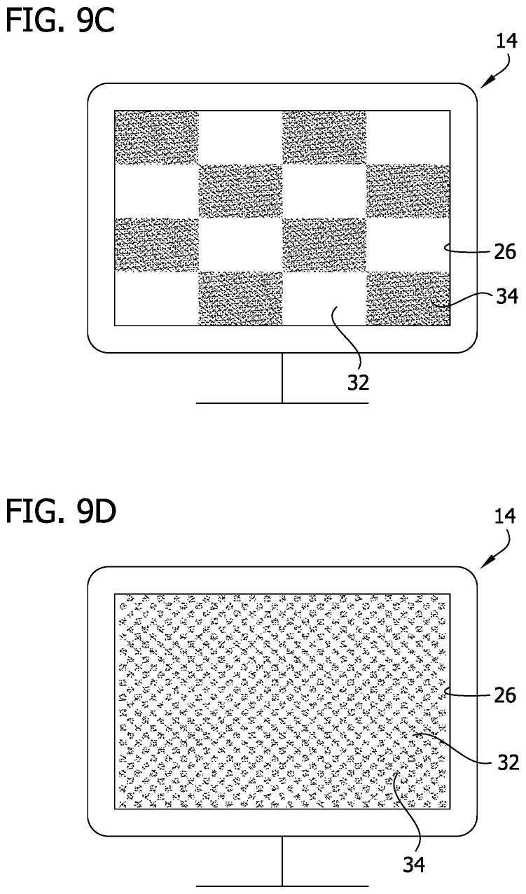

Referring again to FIG. 8, after setting up the system 10 to have the critical distance CD, step 314 includes calibrating the image capturing device 16 to the display 14 as explained in further detail below. Referring to FIGS. 9A-9D, in an exemplary embodiment of the calibration step 314, the profile identification module 18 first subdivides an area of the display screen 26 into uniform quadrants. Then the image capturing device 16 captures an image of the display 14 (FIG. 9B). The characteristics of the display 14 are known so the real world size of the quadrants on the display screen 26 are known. Accordingly, the image capturing device 16 is calibrated by relating the known real world size of the quadrants on the display screen 26 to the image captured by the image capturing device 16. Subsequently, the profile identification module 18 subdivides each quadrant from the first calibration screen into quadrants (so there are 16 contrasting color sections 32, 34 on the display 14), as shown in FIG. 9C. Again, the image capturing device 16 captures an image of the display 14 in this configuration and relates the known size of the color sections 32, 34 on the display 14 as they appear in the captured image. The profile identification module 18 continues this process of further subdividing the color sections 32, 34 and then relating the captured images to the known sizes of the contrasting color sections 32, 34 until the resolution of the display 14 limits further subdivision and/or such that the image capturing device 16 cannot distinguish the contrasting color sections 32, 34 (FIG. 9D). Then, the profile identification module 18 ends calibration. Once this calibration is complete, it can be used to determine the real world dimensions of any pixel-based shape that is projected on the display screen 26 as captured in an image taken by the calibrated image capturing device.

Referring again to FIG. 8, there is a complete calibration of the system, the method 310 can proceed. At step 316, a user places the part P at the desired location on the part stage. Referring to FIGS. 6A-6B, the part P has an actual height and a perceived height observed by the image capturing device 16. The part P is positioned along the z-axis to have a perceived height that is less than or equal to the perceived height of the display screen 26 as viewed by the image capturing device. In an embodiment, the system 10 is configured so that the part P can be positioned at a half-distance HCD of the critical distance CD and meets this constraint.

At the next step 318, the z-axis position(s) of the surface(s) of the part P that are visible in the images captured by the image capturing device 16 are determined. In FIG. 6A, the face of the part P is orthogonal to the z-axis, simplifying step 318 to making a single measurement of the z-axis position of the part surface. At step 320, the profile identification module 18 determines the part profile picture using the visual feedback loop 110 as described above. Subsequently, at step 322, the part profile identification module 18 or another computer device determines part dimensions based on the part profile picture, z-axis position, and calibration of the image capturing device 16 to the display 14.

Consider the example shown in FIGS. 6A-6B for an orthogonal, planar part P placed in front of a Dell P2210 monitor 14 that has a display screen 26 with a size of 474 millimeters by 296 millimeters. Using the calibration of the image capturing device 16 to known dimensions of the display screen 26 as previously described, the system 10 can determine the dimensions of the part based on the image taken by the image capturing device 16. For example, assuming the critical distance is 2.729 meters and the part P is placed at a z-axis position equal to a half-distance HCD of the critical distance (1.365 meters), if the part P is square and has a height equal to the full height of the display screen 26 in the image, the system can determine that the profile of the part P is 148 millimeters by 148 millimeters.

Those skilled in the art will recognize that most parts are not amenable to being oriented so that there is only one exposed planar surface orthogonal to the z-axis. With typical parts, it is therefore necessary to account for variation in the surface of the part along the z-axis. Referring to FIGS. 7A-7C, the system 10 can be modified to include a depth camera 36 to create a two-dimensional z-axis depth map 38 for the part P, as shown in FIG. 7C. In an R3, three-dimensional Euclidean system (X, Y, Z, W), the X factor and Y factor are determined by determining the part profile picture using the visual feedback loop 110 described above, the Z factor is determined by the depth map 38 generated by the depth camera 36, and the critical distance CD is a homogenizing factor ‘W’. The system 10 can thus combine the z-axis data from the depth camera 36 with the part profile picture and the known critical distance CD to determine the dimensions of the profile of the part.

As will be appreciated by one skilled in the art, aspects of the embodiments disclosed herein may be embodied as a system, method, computer program product or any combination thereof. Accordingly, embodiments of the disclosure may take the form of an entire hardware embodiment, an entire software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in any tangible medium having computer usable program code embodied in the medium.

Aspects of the disclosure may be described in the general context of computer-executable or processor-executable instructions, such as program modules, being executed by a computer or processor. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present disclosure may be written in any combination of one or more programming languages, including, but not limited to, an object oriented programming language such as Java, Smalltalk, C++, C# or the like and conventional procedural programming languages, such as the “C” programming language or similar programming languages. The program code may execute entirely on the portable electronic device, partly on the portable electronic device or refrigeration appliance, as a stand-alone software package, partly on the portable electronic device and partly on a remote computer, or entirely on a remote computer or server. In the latter scenario, the remote computer may be connected to the portable electronic device through any type of network, including a local area network (LAN) or a wide area network (WAN), or the connection may be made to an external computer (for example, through the Internet using an Internet Service Provider).

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method of identifying a part, the method comprising:
positioning the part between a display and an image capturing device pointed toward the display; and
conducting a visual feedback loop using the display and the image capturing device to refine a part profile picture on the display corresponding to a profile of the part in an image captured by the image capturing device.

2. The method of claim 1, wherein said conducting the visual feedback loop comprises projecting an initial input picture on a display screen of the display, the input picture including a pattern region.

3. The method of claim 2, wherein said conducting the visual feedback loop comprises capturing an image of the part and the display screen displaying the input image in background behind the part.

4. The method of claim 3, wherein said conducting the visual feedback loop comprises determining part interference with the pattern region in the captured image.

5. The method of claim 4, wherein pattern region comprises an alternating pattern of contrasting color sections and wherein said determining part interference with the pattern region comprises determining, for each color section, whether the part interferes with (i) an entirety of the color section, (ii) none of the color section, or (iii) a portion of the color section less than the entirety.

6. The method of claim 5, wherein said conducting the visual feedback loop further comprises generating a refined picture based on the initial input picture and the determined part interference.

7. The method of claim 6, wherein said generating the refined picture comprises:
for each color section that the part interferes with (i) the entirety of the color section, rendering pixels for the respective color section in a contrast color;
for each color section that the part interferes with (ii) none of the color section, rendering pixels for the respective color section in a background color, and
for each color section that the part interferes with (iii) a portion of the color section less than the entirety of the color section, rendering pixels for the respective section as a pattern of alternating color sections of smaller section size.

8. The method of claim 7, wherein said conducting the visual feedback loop comprises using the refined picture as another input picture and recursively repeating the steps of projecting the input picture on the display screen, capturing an image of the part and the display screen displaying the input image in background behind the part, determining part interference in the captured image, and generating further refined pictures based on each input picture until the further refined picture is the part profile picture having a contrast color region corresponding to the profile of the part.

9. The method of claim 8, wherein each refined picture includes a background color region, a contrast color region, and a pattern region.

10. The method of claim 9, wherein the pattern region has a region size and the region size progressively decreases each time the steps are recursively repeated.

11. The method of claim 9, wherein the pattern region of each refined picture comprises a pattern of alternating color sections having a section size, and wherein the section size progressively decreases each time the steps are recursively repeated.

12. The method of claim 2, further comprising conducting a color setting routine to determine pattern colors for the initial input image before conducting the visual feedback loop.

13. The method of claim 12, wherein said conducting the color setting routine comprises:
projecting a default color setting picture on the display screen, the default color setting picture including a pattern of color sections in alternating default background color and default contrast color;
capturing an image of the part and the display screen displaying the default color setting picture in background behind the part;
determining one of the default background color and the default contrast color lacks contrast with the part in the captured image; and
changing said one of the default background color and the default contrast color to a different color in the initial input image.

14. The method of claim 1, further comprising determining a part type of the part based on the part profile picture.

15. The method of claim 14, wherein said determining the part type comprises comparing the part profile picture to a plurality of pictures of different part types.

16. The method of claim 1, further comprising determining one or more dimensions of the part based on the part profile picture.

17. The method of claim 16, further comprising determining a calibration relating images captured by the image capturing device to real world dimensions of the display and determining a z-axis position of the part along a z-axis extending between the display and the image capturing device, and wherein determining the one or more dimensions of the part comprises relating the part profile picture to the calibration and the z-axis position.

18. The method of claim 17, wherein said determining the z-axis position comprises generating a z-axis depth map of the part using a depth camera.

19. A system for identifying a profile of a part, the system comprising:
a display comprising a display screen, wherein the display is configured to project pictures on the display screen;
an image capturing device pointed toward the display, wherein the system is configured to hold the part between the display and the image capturing device and wherein the image capturing device is oriented to capture images of the part with the display screen in background behind the part; and
a profile identification module controlling the display and the image capturing device for conducting a visual feedback loop to refine a part profile picture on the display screen corresponding to the profile of the part.

20. A method of measuring one or more dimensions of a part, the method comprising:
positioning the part between a display and an image capturing device spaced apart along a z-axis;
determining a z-axis position of the part;
refine a part profile picture on the display corresponding to a profile of the part in an image captured by the image capturing device; and
determining the one or more dimensions of the part based on the z-axis position and the part profile picture.
